(19) United States
(12) Patent Application Publication
(10) Pub. No.: US 2019/0030544 A1
(43) Pub. Date: Jan. 31, 2019

(54) SYSTEMS AND METHODS OF INTELLIGENTLY CONTROLLING EQUIPMENT SUCH AS FOOD WASTE MACHINES

(71) Applicant: BioHiTech America, LLC, Chestnut Ridge, NY (US)

(72) Inventors: William M. Kratzer, III, Harrisburg, PA (US); Robert A. Joyce, Mechanicsburg, PA (US); Clinton J. Martin, Camp Hill, PA (US); Kenneth R. Frazier, Hummelstown, PA (US)

(21) Appl. No.: 16/045,229

(22) Filed: Jul. 25, 2018

Related U.S. Application Data
(60) Provisional application No. 62/536,833, filed on Jul. 25, 2017.

(51) Int. Cl. B02C 18/00; B02C 25/00; G05B 19/05

(52) U.S. Cl. CPC B02C 18/0092; G05B 19/05; B02C 25/00

(57) ABSTRACT

An intelligently controllable food waste disposal system and method are provided. A food waste disposal machine has operational components adapted to assist in the disposal of food waste. A programmable logic controller (PLC) is in data communication with the operational components and configured to control operation of the operational components. A minicomputer is connected to the PLC and adapted to write PLC instructions to the PLC. A network connection is in data communication with both the minicomputer and an analytics cloud. The minicomputer receives data from the analytics cloud and transfers PLC instructions corresponding to the received data to the PLC to thereby alter the operational control of the operational components of the food waste disposal machine via the PLC. The PLC controls the operational components via a default operational program written into the PLC when the PLC detects that the minicomputer is not in communication with the PLC.

### RELATED APPLICATIONS

Priority is claimed from U.S. Provisional Patent Application No. 62/536,833 filed Jul. 25, 2017 entitled “SYSTEMS AND METHODS OF INTELLIGENTLY CONTROLLING EQUIPMENT SUCH AS FOOD WASTE MACHINES”, the entirety of which is incorporated by reference herein.

### BACKGROUND OF THE INVENTION

### Field of the Invention

The invention is directed generally to systems and methods of remotely controlling appliances, and more specifically to systems and methods of controlling a food waste disposal device.

### Description of Related Art

A food waste disposal system, such as an aerobic digester, may process up to 4,800 pounds of food waste every day, including virtually any kind of food waste including vegetables, fruits, meat, fish, poultry, grains, coffee grinds, egg shells and dairy products, with decomposition occurring within 24 hours. The food waste disposal system rapidly digests large volumes of food waste into a liquid effluent suitable for discharge into public sewer systems which is then transported to wastewater treatment plants where it is further digested. It is an ecologically-friendly solution for disposal of food waste at its source.

Food waste disposal systems may be used to replace conventional waste disposal means, e.g., haulage of food waste to landfills, which is costly, inefficient, and possibly harmful to the environment. A typical waste disposal machine is embedded with a Programmable Logic Controller (PLC). The PLC is pre-programmed with a very simple array of tasks. While it is better to use a typical waste disposal machine in this limited manner, this conventional method has its drawbacks, chief among them the limitations of PLCs currently used in industrial equipment. PLCs are memory constrained. PLCs are typically unable to be remotely updated over the Internet. (PLCs are typically not even connected to the Internet.) Moreover, PLCs are not programmed to pull data over the Internet to make software decisions concerning ways to operate the associated machinery in a more efficient manner that will serve its task faster and/or less expensively.

What is needed is a method and system to operate a PLC-driven device such as a food waste disposal machine in a much more sophisticated and effective manner than it was originally designed for without completely redesigning the fundamental device itself.

### SUMMARY OF THE INVENTION

The invention includes systems and methods of intelligently controlling equipment such as food waste disposal machines and the like. This invention introduces a smart, Internet-connected computer embedded in a waste disposal machine with a PLC. The PLC is pre-programmed with a very simple array of tasks. The smart, Internet-Connected computer uses TCP or Serial Modbus to read and write register data to the PLC. Writing to various registers instructs the PLC to take action of various components, such as motors for agitation, pumps for water, pumps for deodorizer, etc. This allows the Internet-Connected computer to drive the waste disposal machine with much more sophisticated business logic than then PLC is capable of doing. Finally, if the Internet-Connected computer loses its connection, then the PLC will revert to executing a very simple version of its traditional logic.

An internet-connected computer is introduced to the waste machine. This computer has two network connections: 1. a connection to the Internet; and 2. a connection the PLC. The connection to the Internet is used to send data about the machine to a centralized reporting system (“the cloud”). The connection to the Internet can also be used to send log files, receive software updates, or receive other important data about the machine that may be stored in the cloud. Examples of this type of data could be (but not limited to): the waste profile of the customer (the types of food waste they normally introduce to the machines), the operating hours of the location, the utilization patterns of the machine over a long period of time, the current weather, holiday information, etc. All of these types of data may be useful in making operational decisions about the machine (to conserve water, energy, etc.).

The computer communicates with the PLC using a standard-industry protocol such as Modbus over Ethernet or a Serial Connection. The computer reads data from the PLC to understand the “state” of the machine (such as load cell or weight data, temperature data, motor feedback data, etc.). The computer also writes data to PLC registers. Writing to various registers instructs the PLC software to perform different operations (turn on a motor using a specific speed and direction, stop a motor, turn on/off water pumps, turn on/off heating elements, etc.).

The computer also updates a register in the PLC as a “keep alive” value. If the PLC notices that this register goes un-updated after a pre-defined amount of time (for example 10 seconds), then the PLC resumes operation using the simplified pre-programmed logic in the PLC.

In one aspect of the invention, the invention is an intelligently controllable food waste disposal system. A food waste disposal machine has a plurality of operational components adapted to assist in the disposal of food waste. A programmable logic controller (PLC) is in data communication with the operational components and configured to control operation of the operational components of the food waste disposal machine. A minicomputer is connected to the PLC and adapted to write PLC instructions to the PLC. A network connection is in data communication with both the minicomputer and an analytics cloud. The minicomputer receives data from the analytics cloud and transfers PLC instructions corresponding to the received data to the PLC to thereby alter the operational control of the operational components of the food waste disposal machine via the PLC. In one aspect of the invention, the received data corresponds to pre-written PLC instructions which the minicomputer transfers to the PLC to thereby alter the operational control of the operational components of the food waste disposal machine via the PLC. In addition or in the alternative, the minicomputer derives PLC instructions from the received data and then transfers the derived PLC instructions to the PLC to thereby alter the operational control of the operational components of the food waste disposal machine via the PLC.

The operational components typically include at least one motor and at least one pump or actuator and the like.

The minicomputer is further adapted to read operational data from the PLC and transmit the read operational data to the analytics cloud. Optionally, the minicomputer periodically resets an indicator number to an address of the PLC indicative of a live connection between the minicomputer and the PLC, while the PLC increments the indicator number between resets of the indicator number by the minicomputer. When the indicator number reaches a predetermined threshold, the PLC utilizes a default operational program written into the PLC and controls the operational components of the food waste disposal system via the default operational program. Alternatively, when the PLC generally detects that the minicomputer is not in communication with the PLC for a predetermined amount of time, the PLC controls the operational components of the food waste disposal system via the default operational program.

In another aspect of the invention, the invention includes a method of intelligently controlling a food waste disposal system. A food waste disposal machine having a plurality of operational components adapted to assist in the disposal of food waste. A programmable logic controller (PLC) is provided in data communication with the operational components. Operation of the operational components of the food waste disposal machine is controlled via the PLC. A minicomputer is provided connected to the PLC and a network connection in data communication with an analytics cloud, the minicomputer writing PLC instructions to the PLC. Data are received by the minicomputer from the analytics cloud, and PLC instructions are transferred to the PLC corresponding to the received data to thereby alter the operational control of the operational components of the food waste disposal machine via the PLC. In one aspect f the invention, the data receiving step includes the step of receiving data corresponding to pre-written PLC instructions, and the transferring step includes the step of the minicomputer transferring the pre-written PLC instructions to the PLC to thereby alter the operational control of the operational components of the food waste disposal machine via the PLC. In addition or in the alternative, the inventive method further includes the step of the minicomputer deriving PLC instructions from the received data, and the transferring step further comprises the step of the minicomputer transferring the derived PLC instructions to the PLC to thereby alter the operational control of the operational components of the food waste disposal machine via the PLC.

Optionally, operational data is read by the minicomputer from the PLC and transmitted to the analytics cloud. Optionally, the minicomputer periodically resets an indicator number to an address of the PLC indicative of a live connection between the minicomputer and the PLC. Optionally, the PLC increments the indicator number between resets of the indicator number by the minicomputer. A default operational program written into the PLC is utilized by the PLC and controls the operational components of the food waste disposal system when the indicator number reaches a predetermined threshold. Alternatively, the PLC controls the operational components of the food waste disposal system via a default operational program written into the PLC when the PLC detects that the minicomputer is not in communication with the PLC. Optionally, the PLC controls the operational components of the food waste disposal system via a default operational program written into the PLC when the PLC detects that the minicomputer is not in communication with the PLC for a predetermined amount of time.

### BRIEF DESCRIPTION OF THE DRAWINGS

FIG. 1 shows a plan view of an exemplary organic waste disposal machine in accordance with the invention.

FIG. 2 shows a front view plan view of the organic waste disposal machine of FIG. 1 in accordance with the invention.

FIG. 3 shows a left side view of the organic waste disposal machine of FIG. 1 in accordance with the invention.

FIG. 4 shows an exemplary schematic diagram of the operation of the waste disposal machine in accordance with the invention.

FIG. 5 is a schematic showing the key components of an exemplary system for controlling a waste disposal machine in accordance in accordance with the invention.

FIG. 6 is a schematic showing an exemplary deployment of the system of FIG. 5 in accordance with the invention.

FIG. 7 depicts logic executed inside of the PLC in accordance with the invention.

FIG. 8 is a block diagram of an exemplary computing environment within which various embodiments of the invention may be implemented.

### DETAILED DESCRIPTION OF THE INVENTION AND DRAWINGS

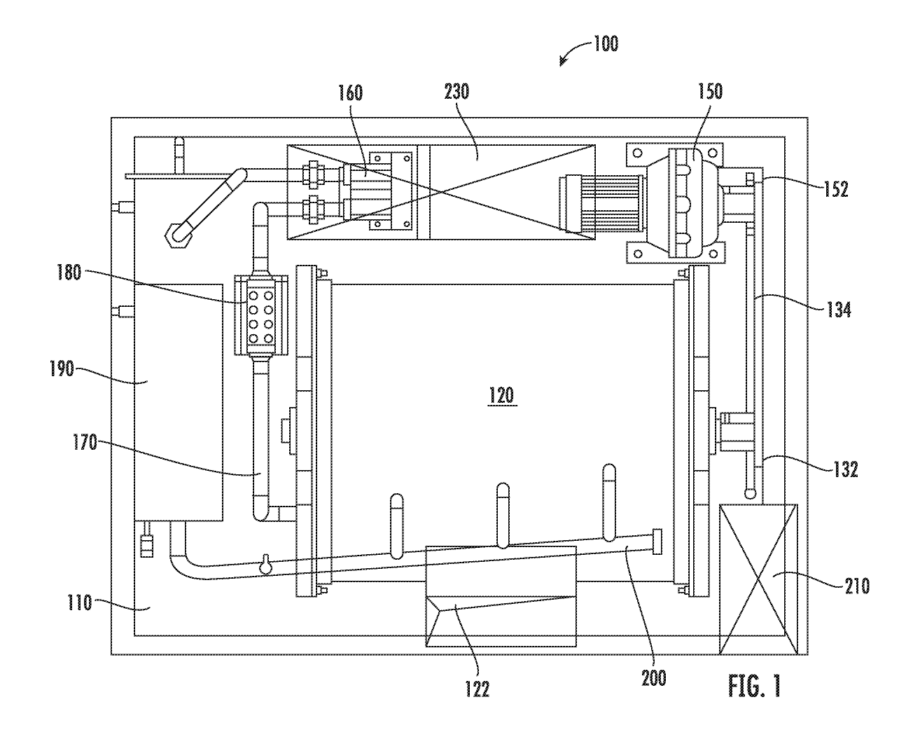

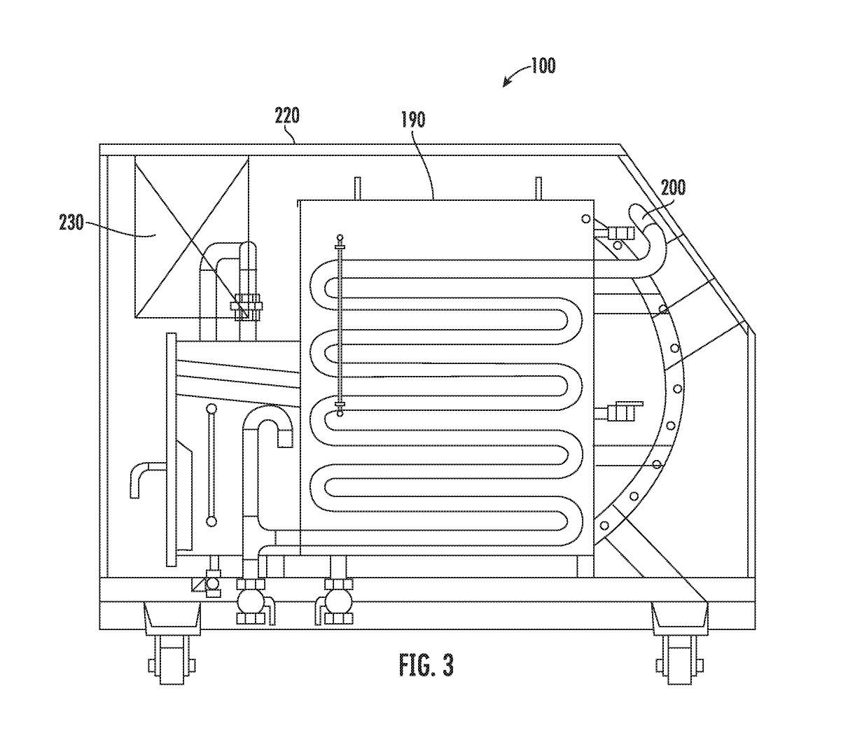

Description will now be given with reference to the attached FIGS. 1-8. It should be understood that these figures are exemplary in nature and in no way serve to limit the scope of the invention, which is defined by the claims appearing hereinbelow.

Referring to FIGS. 1-3, an organic waste disposal machine 100 is depicted and includes a base frame 110, a shell casing 120, a shaft 130, an arm blade 140, a driving motor 150, a ring blower 160, an air pipe 170, a pre-heater 180, a condenser 190, a steam pipe 200, and a control box 210. There are further provided a cover 220 and a chiller 230. The base frame 110 supports the shell casing 120, a cylindrical structure in which an organic waste decomposition occurs by microorganism, actinomyces bovis, which is a kind of special microorganism that is inserted into shell casing 120 for decomposing an organic waste. Shell casing 120 also includes an input door 122 and a discharge door 124. A shaft 130 is rotatable at a center portion of shell casing 120. A shaft gear 132 is engaged to an end portion of shaft 130. A chain 134 is connected between shaft gear 132 and a motor gear 152 of a driving motor 150 for driving shaft 130.

An arm blade 140 includes a plurality of agitating or crushing members connected to an outer surface of shaft 130 for agitating and crushing organic waste placed in the shell casing. A driving motor 150 provides a rotational force to the shaft 130 when a voltage is applied. Arm blades 140 agitate and mix the organic wastes and microorganism in the shell casing 120. A ring blower 160 supplies air into shell casing 120. The microorganism used for an organic waste decomposition is preferably aerotropic bacteria, so that air is needed to be continuously supplied when the organic wastes are decomposed. The ring blower 160 continuously supplies air into shell casing 120 in stable manner. An air pipe 170 connects ring blower 160 and a lower portion of the shell casing 120. The air pipe 170 passes air generated by ring blower 160 to shell casing 120. A pre-heater 180 supplies air heated to a predetermined temperature at which the actinomyces bovis properly decomposes an organic waste, into the interior of shell casing 120, so that it is possible to increase a decomposition efficiency of the organic waste and decrease time required for the decomposition. A condenser 190 liquefies vapor discharged from decomposed organic waste in shell casing 120. A steam pipe 200 provides a passage through which vapor generated by the decomposed organic waste flows to the condenser 190. A cover 220 protects all elements including shell casing 120.

A control box 210 controls the driving time and operation intervals of the driving motor 150, the ring blower 160, and the pre-heater 180 based on a user's selection or a previously set mode. The control box 210 may include a mode selection switch, a ring blower switch and a driving motor switch.

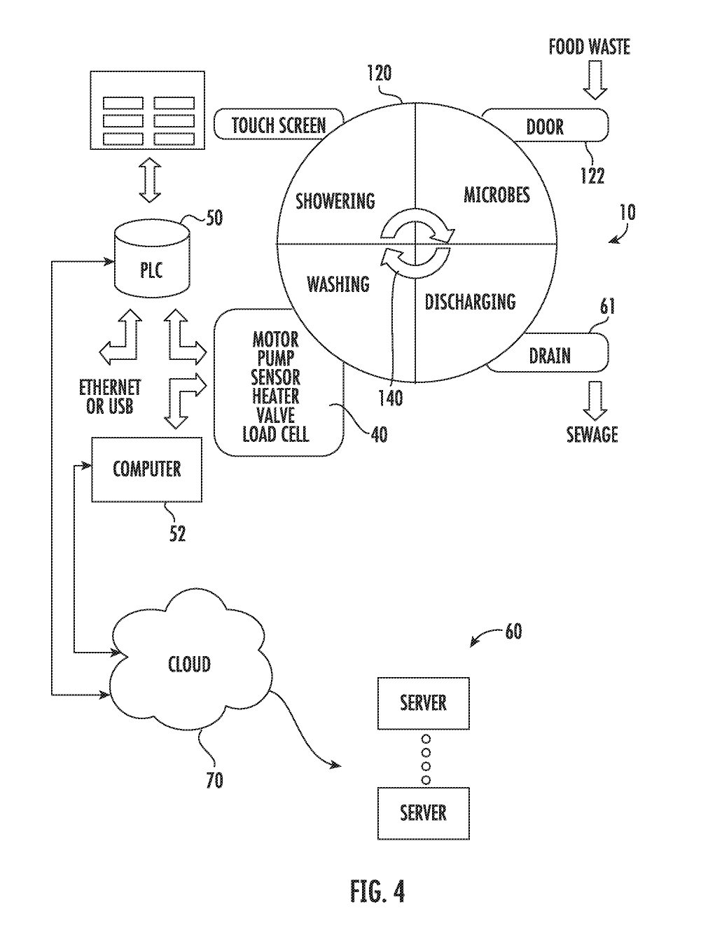

Referring next to FIG. 4, a block diagram depicts the operation of the waste disposal apparatus. Above-described operation of the apparatus 100 is performed by a control device comprising an input means, a processor and a memory device. Preferably, a touch screen is used as an input means and a display device. The hot water tank 40 is equipped with heaters to heat up water and the hot water in the tank 40 is used to conductively heat the mixing basin 10. Heating and maintaining the temperature of the mixing basin 10 is very important for the operation of the apparatus 100 because the activity of microbes is known to be the best at a certain temperature level. Micro-organisms are the most active at 37-42° C. If the temperature of the mixing basin 10 is higher or lower than this range, micro-organism activity drops quickly, resulting in low performance of the apparatus. Once food waste is placed into the mixing basin 10 and the temperature of the mixing basin reaches a predetermined level, preferably at around 15° C., the agitator 140 begins rotating to mix the food waste. Then, microbes in the microbe tank are periodically sprayed onto the food waste through spray nozzles. The microbes decompose protein, fat, sugar, fatty acids, and cellulose in the food waste. By the decomposition of food waste by microbes, leachate is generated and collected in the drain water tank, and then, it is periodically discharged out of the apparatus through a drain pipe 61.

The apparatus 100 further comprises a cleansing device to clean the mixing basin and the drain water tank using high-pressure water and air. After complete decomposition of the food waste, to clean the mixing basin 10 and the drain water tank, hot water in the hot water tank 40 is sprayed at a high speed into the mixing basin 10 through spray nozzles and into the drain water tank through the drain tank spray nozzles. Then, high pressurized air is supplied into the mixing basin 10 to blow down water therein down into the drain water tank to be discharged out of the apparatus 100.

The food waste disposal system unit 100 may be, e.g., a food waste disposal system described in U.S. Pat. No. 7,735,761; U.S. Pat. No. 7,762,713; and U.S. application Ser. No. 13/304,516, which patents and patent application are hereby incorporated by reference.

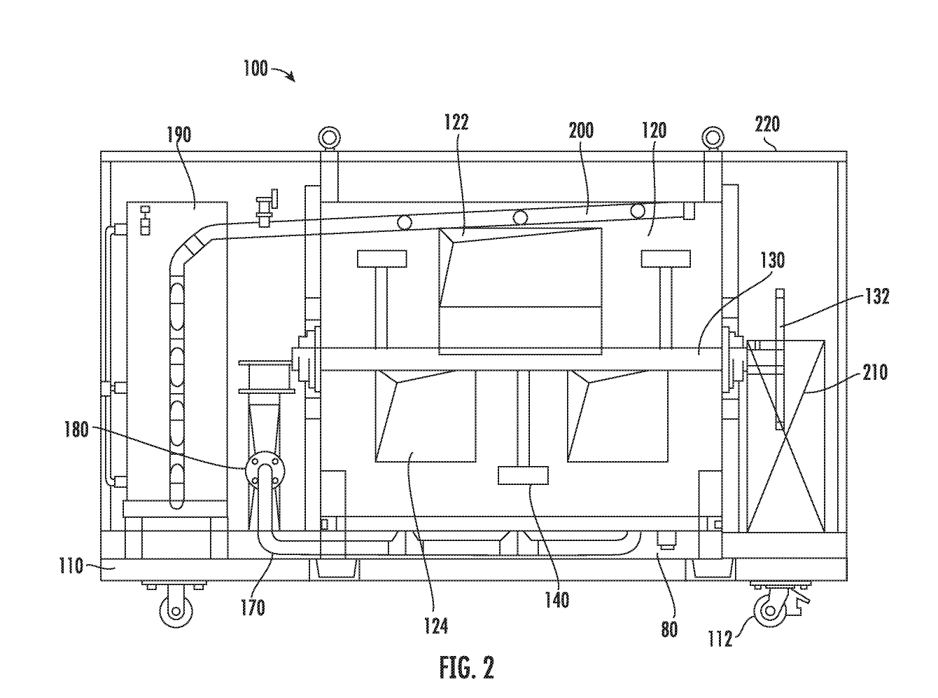

FIG. 2 is a block diagram depicting the operation of the apparatus operated by the control device of the present invention. Above-described operation of the apparatus 100 is performed by a control device comprising an input means, a processor and a memory device. Preferably, a touch screen is used as an input means and a display device.

Waste disposal system or machine 100 may be located locally at the waste producer's site. A waste producer may be, e.g., a grocery store or distribution warehouse, a restaurant, a prison, a hospital, or other large food service business. Machine 100 contains a door 122 that may be opened and closed, and is operable to place waste into machine 100. Waste machine 100 processes and breaks down the waste and converts it into an effluent that may be safely pumped into the sanitary drains connected to external sewage ducts. As described above the waste disposal machine may be configured to perform aerobic digestion. A combination of wood chips, water, and waste may provide a habitat for microorganisms that “eat” and “digest” organic waste (food) that is placed into the waste disposal machine. The by-product of such digestion is effluent that can be safely discharged down a commercial drain.

While an aerobic digester is one exemplary embodiment of a waste disposal machine, it will be appreciated by those skilled in the art that the disclosure is not limited to any specific waste disposal technology, and that the inventive system may be used with any industrial machinery conventionally controlled via a PLC.

Waste disposal machine 100 may contains two or more load cells 80, which scales are typically connected to a load cell indicator 80. The load cell indicator 80 continuously polls the weight on the load cells, which represents the weight of the waste disposal machine, including the waste inside. Waste disposal machine also contains PLC 50 (FIG. 4). The programmable logic controller may be an embedded computer that is typically used to run industrial equipment, such as the waste disposal machine. In one embodiment, the PLC controls the operation of waste disposal machine 100, performing such functions as controlling motors (not shown) used to spin the contents of the habitat, or containment vessel, in which the waste is processed, controlling water rinse cycles for the microorganisms, turning the machine off in response to excess waste being placed into machine 100, and discharging deodorizer on a predetermined interval. PLCs provide reliable and time-sensitive operation in a harsh environment. While PLCs are capable of controlling the basic operation of the machine, they not customarily used for fine tuning the operation of the machine to respond to a variety of changing conditions in real time, such as variations in load, ambient temperature, transient cost of electricity, and many other variables.

A smart computer may be provided in communication with each waste disposal machine or in communication with a number of such machines per computer. The smart computer 52 (see FIG. 4) may be directly interconnected with the weight tracking equipment, e.g., the load cell or a load cell indicator 80, other sensors, e.g., door position sensors, and/or to the PLC. The data interconnection is typically through a wired networked connection, such as an RS/232 serial cable or an Ethernet cable, although wireless networking may also be used. The smart computer gathers information associated with waste disposal machine 100, e.g., weight, state of the door, etc., on a regular predetermined time interval. In one embodiment, the predetermined time interval may be, e.g., one second. This data is tracked and transmitted over a data network to an analytics cloud 60 on a predetermined interval, e.g., every 30 seconds, or when an interesting change of system state occurs, e.g., when the door state changes from “Open” to “Closed”). The data on the smart computer may be cached so that it can be buffered and retransmitted at a later date in the event of a network communication outage. The data may also be collected, compressed, and transmitted in bulk to optimize network bandwidth.

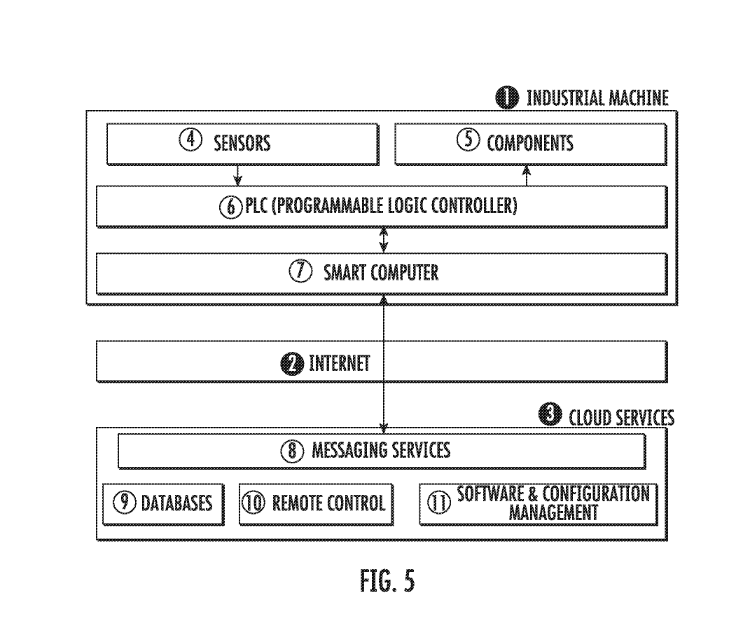

The key components of the inventive system are schematically depicted in FIG. 5.

1. INDUSTRIAL EQUIPMENT—The major piece of this invention is a piece of industrial equipment. Examples of industrial equipment may include (but are not limited to): food waste disposal machine such as described above in reference to FIGS. 1-4, a compactor, a bailer, etc.

The industrial equipment is comprised of the following components that are relevant to this invention:

4. SENSORS—Sensors are pieces of industrial electronics that provide data and feedback to the PLC (6). Examples of sensor include (but are not limited to): temperature sensors, water flows meters, motor feedback from a variable frequency drive, door sensors, and load cells.

5. COMPONENTS—Components are key physical parts that are controlled by the PLC (6). This includes (but is not limited to): motors, pumps, actuators, contactors, relays, heating systems, tower lamps, LEDs, etc.

6. PLC (Programmable Logic Controller)—The programmable industrial control computer whose main purposes are to read sensor (4) input data, execute limited program logic, and control components (5) (typically through contactors, relays, motor drive functions, etc.)

In this invention, the PLC executes a very simple level of logic to perform the following activities:
read sensor data from Sensors (4) and store that data in memory
control machine Components (5) as indicated by various data in memory
a simplified operational plan (program) to control the Components. This simplified plan is only run if the Smart Computer (7) requests the system to do so or if the Smart Computer is no longer connected to the PLC
check to see if the Smart Computer (7) is connected to the PLC and to see if the Smart Computer is desiring to control the PLC. Connectivity is checked through the PLC memory address that is incremented continuously by the PLC (and reset frequently when the Smart Computer is connected). If the Smart Computer is not connected, this memory address will continually by incremented. When a certain threshold is reached, the PLC will assume that the Smart Computer is no longer connected, and will assume that the PLC should control the execution of its simplified program logic.

7. SMART COMPUTER—This computer is connected to both the PLC (6) and the Internet. This computer is typically a much more powerful and more versatile computer than a PLC. While the Smart Computer may not have all the sensor reading capabilities and component control capabilities of a PLC, the Smart Computer is distinguished by its connectivity to the Internet, more memory and storage (which can allow it to run more sophisticated software than what runs on the PLC), and a more sophisticated operating system which allows for more complex types of software to run on the smart computer and the allows for more sophisticated software update mechanisms. The Smart Computer usually communicates to the PLC using industry-standard protocols such as Modbus over TCP/Ethernet or a serial connection.

The Smart Computer will perform the following functions:
periodically (several times per second) read data from the PLC memory addresses (typically data from Sensors (4)).
periodically reset a counter in a memory address on the PLC (6) to reaffirm to the PLC that the smart computer is connected.
execute a more complex and sophisticated machine operational plan (through a software program) that will result in the periodically writing of data registers to the PLC (6) to control the various Components (5) of the machine.
periodically connect to the Cloud Services (3) Messaging Services (8) to look for useful data to download from Database (9)
periodically connect to the Cloud Services (3) Messaging Services (8) to look for any Remote Control (10) commands
periodically connect to the Cloud Services (3) Messaging Services (8) to look for any Software Updates or Configuration Parameters (10)

2 INTERNET—The industrial equipment (through the Smart Computer (3)) is connected to the Internet to have access to Cloud Services (3). These cloud services provide data, messaging, software, configuration, services to the Smart Computer. Data is typically transmitted over the Internet using industrial standard protocols such as (but not limited to) HTTP (Hypertext Transfer Protocol) over SSL (Secure Sockets Layer) or TLS (Transport Layer Security)

3 CLOUD SERVICES—Cloud Services reside on the Internet and provide a centralized system for managing many industrial machines (through the Smart Computer (7)).

In the scope of this invention, there are several key elements to Cloud Services, include:

8. MESSAGING SERVICE—The messaging service acts as the gateway (or gateways) for all communications between various Cloud Service (3) functions and the Smart Computers (7) in the field. Typically, Smart Computers (7) connect routinely to the Messing Services to query or send data to databases, look for configuration information, software updates, and remote control actions.

9. DATABASES—Databases may be used to store operational machine data collected through the Sensors (4) by the PLC (6) through the Smart Computer (7). Databases may also store useful data external to the machine that the Smart Computer (7) may use in its sophisticate program logic. Examples of database data may include: machine utilization patterns, weather data, service history, customer information, geo-location data of the machine, etc. Database information may be requested by the Smart Computer (7) over the Internet (2) through the Messaging Service (8) to the database.

10. REMOTE CONTROL—Remote Control services allow a customer support technician, a customer, or service technicians to remotely query or operate the machine. These data collection commands or machine actions commands are delivered to the Smart Computer (7) over the internet (2) through the Messaging Services (8).

11. SOFTWARE CONFIGURATION & MANAGEMENT—Remote configuration of the Industrial Machine (1) can be controlled in the Cloud through this service. Configuration Parameters are delivered to the Smart Computer (7) over the Internet (2) through the Messaging Service (8). Configuration Parameters may adjust execution of software on the Smart Computer (7) which ultimately drives the PLC's (6) execution of the Industrial Machine (1).

Likewise, Software payloads may be used to update various software on the Smart Computer (7) over the Internet (2) through the Messaging Service (8). This allows the Smart Computer's software stack to be routinely updated.

Exemplary Deployment

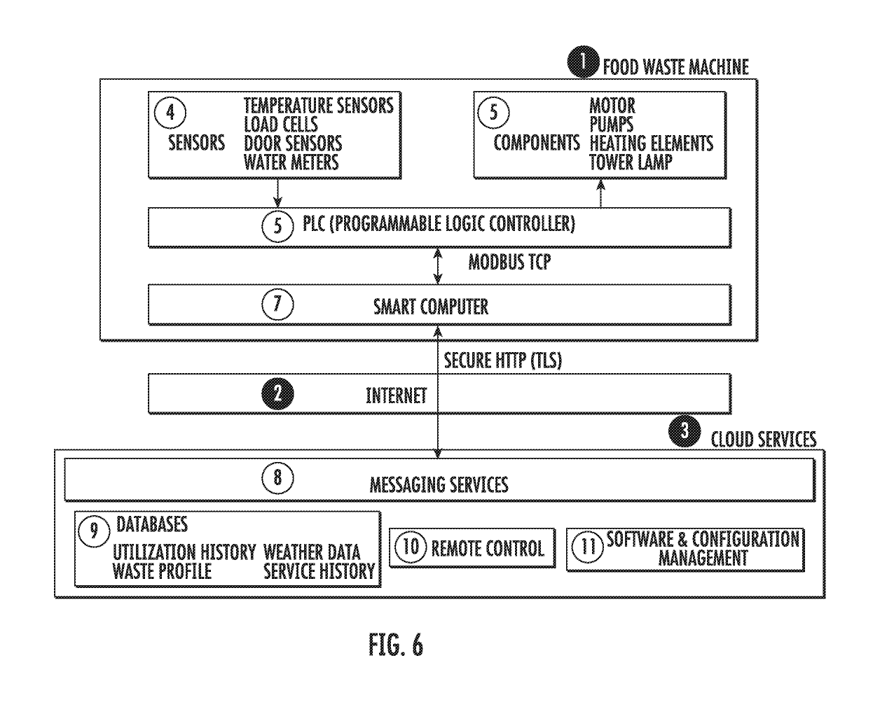

FIG. 6 depicts how these system components may be deployed for a food waste disposal machine:

Food Waste Disposal Machine (1) is a machine that converts food waste into wastewater using a process called “Aerobic Digestion”. Aerobic Digestion uses oxygen and microorganisms to naturally break down the solid contents of food waste into a waste water that can be discharged into the sanitary sewer system. The food waste machine provides a warm, moist, oxygenated environment for the microorganisms to breakdown food waste.

Sensors (4) inside of the machine include:
Temperature sensors to ensure that the environment inside of the machine stays warm and to ensure that warm water is being used. Temperature is a key component to the microbiology of the machine.
Door sensors to know when the food hatch door is opened and waste is being placed inside of the machine (effectively, this denotes when a user of the machine is placing waste inside of the machine)
Load Cells are used to track how much food waste is inside of the machine (and how “full” the machine is)
Water Meters are used to track water usage by the machine or to ensure that there is adequate water pressure coming into the machine.

Components (5) inside of the machine include:
Motor to control a series of paddle arms inside of the machine to ensure that food waste is continually agitated and introduced to oxygen, a key component of the biological process.
Pumps to control water continually being introduced into the food habit to ensure an optimal environment for microorganisms. Pumps may also be used for cleaning functions.
Heating Elements to ensure that the environment of the food habitat stays warm for the biological process.
Tower Lamp is a visual indicator for the end-user if the machine can be used (“Green” light or “Red” light). For example, the PLC may trigger the tower lamp in the machine to turn Red when the machine's capacity is full due to reading from the Load Cells.

PLC (6) includes a simple program executing to perform the following actions if the Smart Computer (7) is not connected or not actively controlling the PLC:
Reading sensor data.
Turning the motor on and off on a routine schedule to agitate and aerate food waste in the food habitat.
Turning on various water pumps on and off on a routine schedule keep the moisture inside of the food habitat high and to routinely clean other components inside of the machine.
Stopping the motor if the and the water pumps if the Food Hatch Door on the machine is opened for safety and sanitary reasons.
Turning on heating elements at various times to ensure that the machine and the food waste stays warm.

Smart Computer (7) the smart computer runs a more sophisticated program to control the PLC (6) and ultimately the entire Industrial Machine (1) and its Components (5). The Smart Computer does a number of things, including running a program that:
Reads data from the PLC (6) memory addresses which contains readings form Sensors (4), such as water temperature, ambient temperature, load cell data, etc.
Write data to the PLC (6) to reset a memory address on the PLC that is continually incrementing. This tells the PLC (6) that the Smart Computer (7) is still actively connected and working.
Writes data to the PLC (6) memory addresses to instruct the PLC (6) to control the various components (5) of the machine, such as the motor to run the agitator, the water showering functions to keep the food chamber moist, the water washing functions to keep the machine clean, and the heating elements to keep the machine warm.
Routinely connects to the Cloud (3), checking for new, useful database data, remote control data, configuration changes, or new software to be installed.
If a Remote Control (10) command is found, the Smart Computer (7) will instantly instruct the PLC (6) to perform various component operations based on the commands instruction. For example: a “shutdown” command may have the Smart Computer turn off all water, heating, and motor functions.
The Smart Computer (7) uses configuration data and database data (11) from the cloud to make more advanced command and control decisions for the machines.

Examples of Smart Control may include (but are not limited to):
The machine may change its water usage and motor usage throughout the day based on time of day, the amount of food waste currently in the machine, the motor feedback from the PLC, or from data stored in the cloud database (9), including:
   Historical Utilization patterns
   Weather data based on the machine geo-location
   Service history and consumables replacement
   The type of waste the customer places into the machine (the “waste profile”)
   Issue history (units that may have a history of clogging may use more washing water, for example to reduce problem-some clogs)

One example of Smart Control can come from weather data. If it is detected that the temperature in the location of the machine is below a certain threshold, the operation of one or more components of the machine may be affected. For example, it is desirable to use warm water in the food digestion process, however if a machine is in a cold location and has a long pipe run, the water may not heat up sufficiently by the time it reaches the digester. To address this type of situation, the instructions for cycle runs can be changed to make them run longer (e.g., three minutes instead of 30 seconds) but less frequently. This would yield a greater chance of warm water reaching the machine. Thus, the minicomputer here would receive weather or temperature data, and in response to that data, alter the timing of the machine's cycles accordingly by adjusting the PLC instructions accordingly.

PLC Logic Flow

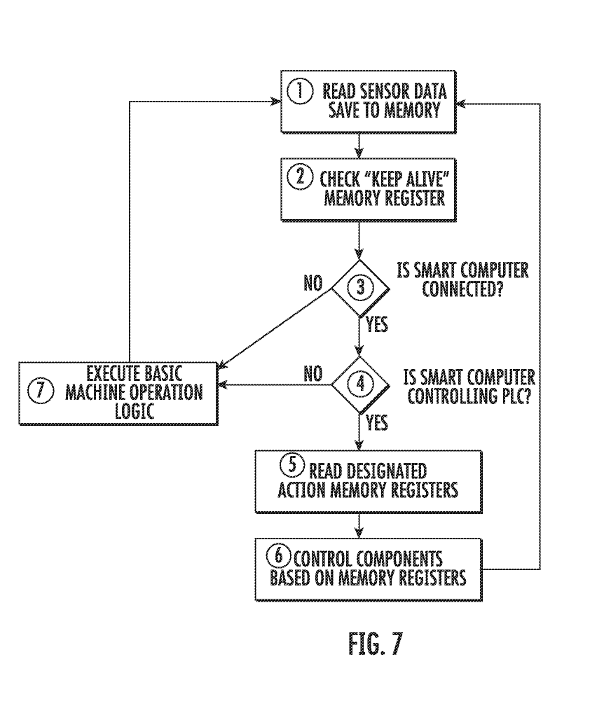

FIG. 7 depicts logic executed inside of the PLC in accordance with the invention.

The PLC generally runs in a loop where the following activities are performed:
1. Read sensor data from inputs and write data into memory locations. Go to step 2.
2 Check to see if the Smart Computer is connected. Increment the “keep alive” memory register. Go to step 3.
3 If the “keep alive” memory register is greater than a pre-configured value, assume that the Smart Computer is NOT connected and jump to step 7, otherwise go to step 4.
4 Check to see if the Smart Computer is in control of the PLC. This is done by examining a data register. If the Smart Computer is NOT in control of the PLC, jump to step 7. Otherwise go to step 5.
5 At this point the Smart Computer is in control of the PLC. Examine pre-designated memory locations (registers) that may have been written by the Smart Computer.
6 Activate (turn on/off) various components controlled by the PLC based on the data in the registers read in Step #5. Resume executing at Step 1.
7 At this point the Smart Computer is NOT in control of the PLC. Continue executing simplified machine operations control logic to keep the machine running in a minimum viable state. Resume executing at Step 1.

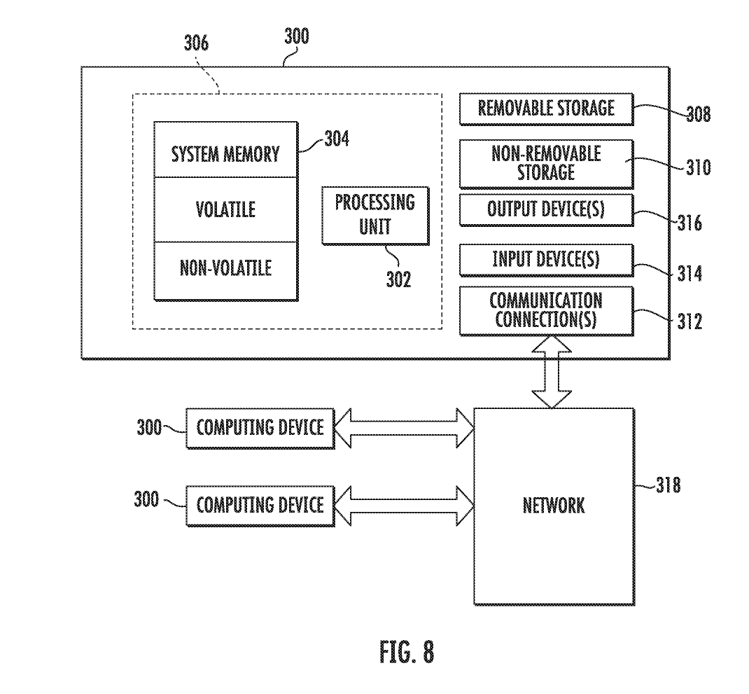

FIG. 8 depicts an exemplary computing environment in which various embodiments of the invention may be implemented. The computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal electronic devices such as smart phones and smart watches, tablet computers, personal computers (PCs), server computers, handheld or laptop devices, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 8 by dashed line 106. Computing device 100 may have additional features/functionality. For example, computing device 100 may include additional storage (removable and/or non-removable) including, but not limited to, magnetic or optical disks or tape. Such additional storage is illustrated in FIG. 8 by removable storage 108 and non-removable storage 110.

Computing device 100 typically includes or is provided with a variety of computer-readable media. Computer-readable media can be any available media that can be accessed by computing device 100 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 104, removable storage 108, and non-removable storage 110 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 100. Any such computer storage media may be part of computing device 100.

Computing device 100 may also contain communications connection(s) 112 that allow the device to communicate with other devices. Each such communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. The term computer-readable media as used herein includes both storage media and communication media.

Computing device 100 may also have input device(s) 114 such as keyboard, mouse, pen, voice input device, touch input device, etc. Output device(s) 116 such as a display, speakers, printer, etc. may also be included. All these devices are generally known and therefore need not be discussed in any detail herein except as provided.

Notably, computing device 100 may be one of a plurality of computing devices 100 interconnected by a network 118, as is shown in FIG. 8. As may be appreciated, the network 118 may be any appropriate network; each computing device 100 may be connected thereto by way of a connection 112 in any appropriate manner, and each computing device 100 may communicate with one or more of the other computing devices 100 in the network 118 in any appropriate manner. For example, the network 118 may be a wired or wireless network within an organization or home or the like, and may include a direct or indirect coupling to an external network such as the internet or the like.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as USB flash drives, SD cards, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 118 or a distributed computing environment. Still further, aspects of the presently disclosed subject matter may be implemented in or across a plurality of processing chips or devices, and storage may similarly be effected across a plurality of devices in a network 118. Such devices might include personal computers, network servers, and handheld devices, for example.

The invention has several advantages. First, the logic in the PLC remains very simple and plain, as most of the complexity is moved to the Internet-connected computer). This means there is less need to update the software in the PLC, which is typically difficult to do remotely, and costly from a business standpoint since it may require on-site access. Second, the Internet-Connected computer can be updated remotely over the internet. This allows the functionality and software of the industrial waste equipment to be updated more frequently, at a fraction of the cost. Third, the Internet-Connected computer has more storage, memory, and more modern software that can take advantage of cloud-based data, more complicated algorithms, etc. This allows the machine to operate more sophisticatedly. Additionally, if the Internet-Connected computer loses connection to the PLC, the PLC will “revert” back to running in a predefined, simple mode of operation.

The invention is not limited to the above description. For example, although the above description centers around a waste disposal machine, the invention is applicable to many types of industrial equipment, such as very large washing machines, dryers, dishwashers, other types of waste processing systems such as anaerobic digesters, and other industrial machines that run on cycles or are otherwise analogous in operation.

Having described certain embodiments of the invention, it should be understood that the invention is not limited to the above description or the attached exemplary drawings. Rather, the scope of the invention is defined by the claims appearing hereinbelow and includes any equivalents thereof as would be appreciated by one of ordinary skill in the art.

What is claimed is:

1. An intelligently controllable food waste disposal system comprising:
a food waste disposal machine having a plurality of operational components adapted to assist in the disposal of food waste;
a programmable logic controller (PLC) in data communication with said operational components and configured to control operation of said operational components of said food waste disposal machine;
a minicomputer connected to said PLC and adapted to write PLC instructions to said PLC; and
a network connection in data communication with both said minicomputer and an analytics cloud,
wherein said minicomputer receives data from said analytics cloud and transfers PLC instructions corresponding to said received data to said PLC to thereby alter the operational control of the operational components of said food waste disposal machine via said PLC.

2. An intelligently controllable food waste disposal system according to claim 1, said operational components further comprising at least one pump or actuator.

3. An intelligently controllable food waste disposal system according to claim 1, wherein said minicomputer is further adapted to read operational data from said PLC and transmit said read operational data to said analytics cloud.

4. An intelligently controllable food waste disposal system according to claim 1, wherein said minicomputer periodically resets an indicator number to an address of said PLC indicative of a live connection between said minicomputer and said PLC, said PLC incrementing said indicator number between resets of said indicator number by said minicomputer.

5. An intelligently controllable food waste disposal system according to claim 4, wherein when said indicator number reaches a predetermined threshold, said PLC utilizes a default operational program written into said PLC and controls said operational components of said food waste disposal system via said default operational program.

6. An intelligently controllable food waste disposal system according to claim 1, said PLC further comprising a default operational program written into said PLC, wherein when said PLC detects that said minicomputer is not in communication with said PLC for a predetermined amount of time, said PLC controls said operational components of said food waste disposal system via said default operational program.

7. An intelligently controllable food waste disposal system according to claim 1, wherein said received data corresponds to pre-written PLC instructions which said minicomputer transfers to said PLC to thereby alter the operational control of the operational components of said food waste disposal machine via said PLC.

8. An intelligently controllable food waste disposal system according to claim 1, wherein said minicomputer derives PLC instructions from said received data and then transfers said derived PLC instructions to said PLC to thereby alter the operational control of the operational components of said food waste disposal machine via said PLC.

9. A method of intelligently controlling a food waste disposal system, comprising the steps of:
providing a food waste disposal machine having a plurality of operational components adapted to assist in the disposal of food waste;
providing a programmable logic controller (PLC) in data communication with the operational components;
controlling operation of the operational components of the food waste disposal machine via the PLC;
providing a minicomputer connected to the PLC and a network connection in data communication with an analytics cloud, the minicomputer writing PLC instructions to the PLC;
the minicomputer receiving data from the analytics cloud; and
transferring PLC instructions corresponding to the received data from the minicomputer to the PLC to thereby alter the operational control of the operational components of the food waste disposal machine via the PLC.

10. A method of intelligently controlling a food waste disposal system according to claim 9, the operational components further comprising at least one pump or actuator.

11. A method of intelligently controlling a food waste disposal system according to claim 9, further comprising the step of the minicomputer reading operational data from the PLC and transmitting the read operational data to the analytics cloud.

12. A method of intelligently controlling a food waste disposal system according to claim 9, further comprising the steps of:
the minicomputer periodically resetting an indicator number to an address of the PLC indicative of a live connection between the minicomputer and the PLC; and
the PLC incrementing the indicator number between resets of the indicator number by the minicomputer.

13. A method of intelligently controlling a food waste disposal system according to claim 12, further comprising the step of the PLC utilizing a default operational program written into the PLC and controlling the operational components of the food waste disposal system via the default operational program when the indicator number reaches a predetermined threshold.

14. A method of intelligently controlling a food waste disposal system according to claim 9, further comprising the step of the PLC controlling the operational components of the food waste disposal system via a default operational program written into the PLC when the PLC detects that the minicomputer is not in communication with the PLC.

15. A method of intelligently controlling a food waste disposal system according to claim 14, wherein the PLC controls the operational components of the food waste disposal system via a default operational program written into the PLC when the PLC detects that the minicomputer is not in communication with the PLC for a predetermined amount of time.

16. A method of intelligently controlling a food waste disposal system according to claim 9, wherein said data receiving step further comprises the step of receiving data corresponding to pre-written PLC instructions, and wherein said transferring step further comprises the step of said minicomputer transferring said pre-written PLC instructions to said PLC to thereby alter the operational control of the operational components of said food waste disposal machine via said PLC.

17. An intelligently controllable food waste disposal system according to claim 1, further comprising the step of said minicomputer deriving PLC instructions from said received data, wherein said transferring step further comprises the step of said minicomputer transferring said derived PLC instructions to said PLC to thereby alter the operational control of the operational components of said food waste disposal machine via said PLC.
